(19) United States
(12) Patent Application Publication
(10) Pub. No.: US 2013/0103477 A1
(43) Pub. Date: Apr. 25, 2013

(54) Transaction Management System and Method

(71) Applicant: Ollie Ackley, St. Charles, MO (US)

(72) Inventor: Ollie Ackley, St. Charles, MO (US)

(21) Appl. No.: 13/447,612

(22) Filed: Apr. 16, 2012

Related U.S. Application Data
(63) Continuation-in-part of application No. 13/277,529, filed on Oct. 20, 2011.

(51) Int. Cl. G06Q 30/06; G06Q 30/02; G06Q 20/12

(52) U.S. Cl. 705/14.23; 705/26.41; 705/16

(57) ABSTRACT

A method of managing some or all financial aspects of a commercial transaction entered into by a vendor and a consumer, and automatically and using a portable, internet enabled telecommunications device by the consumer, effecting payment by the consumer, extending to processing of payments by third parties such as banks, the Federal Reserve system, and the like. The method may include supporting elements such as establishing or accessing credit, issuing payment reminders, applying discounts, maintaining and transmitting transaction and account information, issuing coupons and gift cards, managing installment purchases, and transmitting postings pertaining to commercial transactions to social networking sites. All necessary inputs from the consumer may be of the type entered into the portable telecommunications device.

### REFERENCE TO RELATED APPLICATION

This application is a Continuation in Part of U.S. Non-Provisional Application No. 13/277,529, filed Oct. 20, 2011.

### FIELD OF THE INVENTION

This application relates generally to managing transactions and more particularly to systems and methods for electronically managing transactions.

### BACKGROUND OF INVENTION

The field of processing of commercial transactions, such as retail purchases, impinges upon convenience for both vendors and purchasers. Currently, the most widely used system utilizes a cash register located at the point of sale. A clerk enters pertinent data into the cash register, such as the nature of merchandise being purchased, the price, the quantity or weight of the merchandise, and the like. Payment may be made electronically using credit or debit cards or the like, as well as by cash or check. A paper receipt is typically generated following payment.

Electronic processing of payment may be made, using wireless and hardwired telecommunications systems. This processing is increasingly being done over the internet. While point of sale transactions include the use of the internet for the purposes of processing credit or debit card payments, these transaction still frequently require physical cards, physical receipts and the like. Therefore, there is a significant need to further manage these transactions electronically to enhance security, increase the speed and eliminate the need for physical items such as plastic credit or debit cards, paper receipts, etc. Furthermore, electronic handling of the entire transaction may be extended to financial support institutions such as banks and their associated Automated Clearinghouse systems, the Federal Reserve System, and the like.

### SUMMARY OF THE INVENTION

The present invention contemplates an integrated, wireless system for managing most if not all informational aspects of a commercial transaction to be performed and completed, including participation of financially relevant entities not immediately participating at the point of sale. This is done using a wireless, portable, internet enabled telecommunications device by the consumer or purchaser. Once a transaction is entered, many functions which are ordinarily unseen to the purchaser may automatically be performed, such as transferring payments from an asset account or a credit account. Record keeping appropriate for both the vendor and the consumer may be automatically generated, with reports transmitted wirelessly to memory of data processors of either of these parties. The system may include transfer of funds from a bank or a credit line, essentially resulting in virtual generating and handling of checks for example. The system may integrate peripheral aspects of commercial transactions, such as factoring in discounts, implementing promotions, managing installment sales, generating virtual gift cards and coupons, and others.

The system may automatically initiate functions performed after the point of sale by involved parties and institutions, using generally utilized telecommunications systems including the internet.

The system may incorporate participation in social networking sites. The system integrates support functions such as archiving, encryption and other security measures, and others.

### BRIEF DESCRIPTION OF THE DRAWINGS

The drawings, when considered in connection with the following description, are presented for the purpose of facilitating an understanding of the subject matter sought to be protected.

FIG. 1 is a diagrammatic representation of the parties and apparatus of the novel system; and

FIG. 2 is a block diagram summarizing steps of a method of conducting transactions using the novel system.

### DETAILED DESCRIPTION

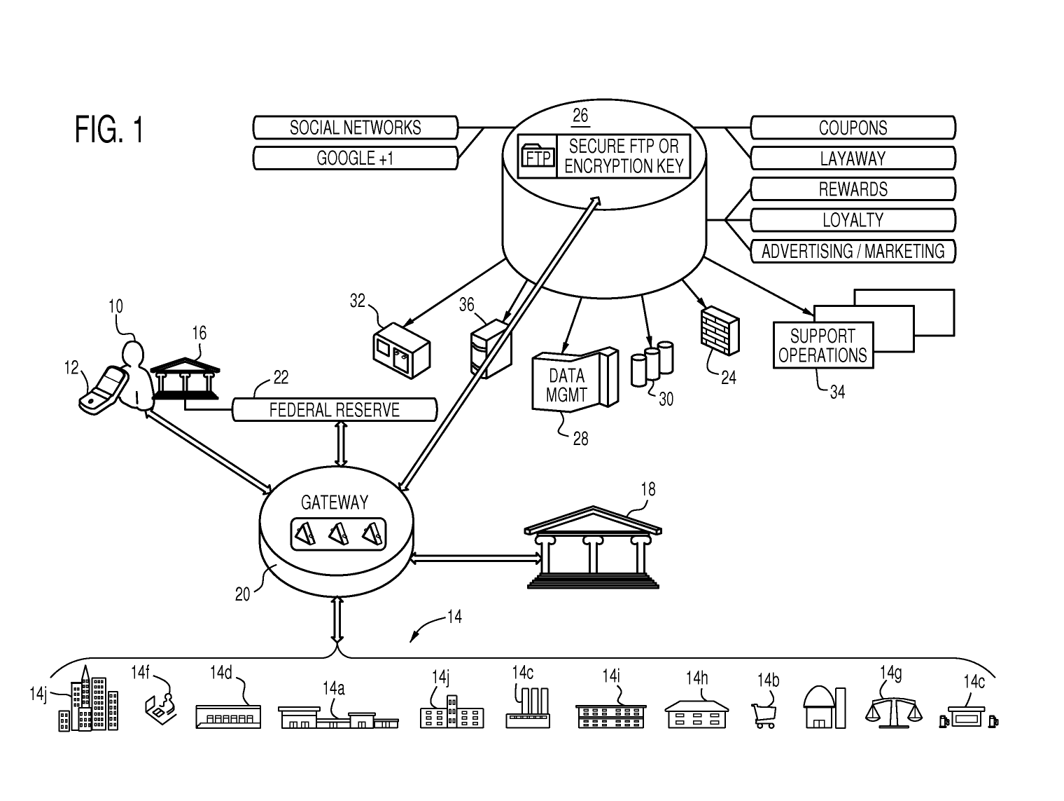

FIG. 1 of the drawings depicts physical apparatus which may come into play in a system of conducting commercial financial transactions among consumers, vendors, and the national banking system. The system functionally brings together at least one consumer 10 having a portable, internet enabled telecommunications device having data entry and data receiving capability, which will be referred to hereinafter generically as a smartphone 12, and at least one vendor having a payment data processor disposed to receive and transmit data wirelessly pertaining to commercial financial transactions related to commercial products sold by the vendor. In FIG. 1, the vendor may be for example any of conventional retailers or stores 14a, internet based merchants 14b, motor fuel retailers 14c, wholesalers 14d, industrial entities 14e, providers of professional services such as a doctor 14f and a lawyer 14g, an agency 14h providing services such as property management, a provider of lodging such as a hotel 14i, a provider 14j of office space, an institution such as a school 14k, or an agricultural facility 14l. The above are only representative of many types of vendors of goods or services or both. Hereinafter, vendors will be referred to in the singular as a vendor 14, although obviously many vendors such as the vendors 14a . . . 14j and others may utilize the novel system.

It should also be mentioned here that although commercial transactions conducted with the vendor 14 are referred to in terms of sales, other types of transactions such as leases and rental of goods and properties may enjoy the benefits of the novel system. Hence the term “sale” will be understood to encompass leases and rentals.

The smartphone 12 is set forth as an advantageous form of portable, internet enabled telecommunications device, but need not be limited to the form depicted. The smartphone 12 may take the form of personal computers, desktop computers, laptop computers, tablet computers, or any suitable telecommunications device, including, but not limited to, VoIP telephones, smart telephones or wireless devices, such as cellular telephones, personal digital assistants (PDA), communications enabled mp3 players, etc.

A vendor 14 may have a physical presence such as a store such as 14a and may have a point of sale data entry device or electronic terminal such as a cash register (not separately shown), which may comprise a data processor, memory, and have data entry and telecommunications capability and may be internet enabled for example. The electronic terminal ma be located at the physical point of sale of the vendor 14, such as at a retail store such as the retail store 14a. Although these characteristics of the vendor point of sale data entry device are desirable, none of these characteristics of the vendor point of sale data entry device is critical to the invention. By contrast, the telecommunications capability of the smartphone 12 is critical to the invention.

Because funds are electronically transferred, the consumer 10 may have a financial institution such as a consumer bank 16 having a financial account serving the consumer 10 enabling funds to be transferred in payment of purchases from the vendor 14. For his part, the vendor 14 may have a financial institution such as a vendor bank 18 disposed to electronically accept payments and generate virtual receipts, electronic reports related to purchases and financial and other details related to the purchases. The consumer bank 16 and the vendor bank 18 preferably each comprising a data processor, memory, and apparatus for transmitting and receiving wireless communications, and to receive, record, process, and transmit data wirelessly.

A gateway 20 serves to connect communications among the smartphone 12, the vendor 14, the consumer bank 16, the vendor bank 18, and involved additional parties such as the Federal Reserve System 22. The gateway 20 may comprise a remote transaction server 26 including a database stored in memory (the database and memory are collectively indicated by a reference numeral 28) and associated telecommunications apparatus (neither separately shown) for transmitting and receiving wireless communications, and to receive, record, process, and transmit data pertaining to commercial financial transactions wirelessly.

The function of the gateway 20 may be performed by a supervisory party separate from the vendor 14, either of the banks 16 or 18, or the Federal Reserve System 22. For example, the supervisory party may provide its services as a commercial service to which a vendor 14 subscribes for example. Preferably, the gateway 20 may have a security facility 24 for securing telecommunications among the participants of the system of the present invention. The security facility 24 will be understood to encompass software and data processing apparatus as necessary to accomplish encryption of electronic messages and other security measures that may be desirable.

Other functions that may be provided using software based and other facilities by the gateway 20 may include an archive 30, a diagnostic facility 32, and an administrative support facility 34. These facilities 30, 32, 34 will also be understood to encompass software and data processing apparatus necessary to accomplish their intended functions. The facilities 24, 30, 32, and 34 may be conventional, known, and therefore need not be detailed further herein.

The gateway 20 may be configured to communicate payment instructions to the either or both of the consumer bank 16 and the vendor bank 18, and the Federal Reserve System 22. The gateway 20 may be configured to verify the authenticity of the consumer employing any suitable technique known in the art, including but not limited to passwords, cookies, biometric verification or any other suitable technique or means. The gateway 20 may be configured to verify payment and notify the vendor 14 directly or through the vendor bank 18 that it has received payment instructions from the consumer 10 (e.g., through the smartphone 12). The gateway 20 may also be configured to securely coordinate electronic payment from the consumer bank 16 to the vendor bank 18. The gateway 20 may coordinate payments in any suitable manner. In one non-limiting example, the gateway 20 may employ existing credit card payment infrastructure, ACH, Check21, or any other suitable technique and/or infrastructure.

The gateway 20 may also provide output files or otherwise generate bookkeeping materials for the consumer 10 and/or the vendor 14. Illustrative transaction management and reporting options include, without limitation, Conversion Only, Verification with Conversion; Guarantee with Conversion, output files, return notification, returns re-presentment, retrieval request, refunds, credits, eChecks and statistic showing consumer product preferences, etc.

As shown in FIG. 1, the gateway 20 may include a memory and a processor to accommodate the forgoing. However, it will be appreciated that the forgoing may be implemented in hardware, software, or a suitable combination of hardware and software, and which can be one or more software systems operating on a general purpose server platform. As used herein, a hardware system can include discrete semiconductor devices, an application-specific integrated circuit, a field programmable gate array or other suitable devices. A software system can include one or more objects, agents, threads, lines of code, subroutines, separate software applications, user-readable (source) code, machine-readable (object) code, two or more lines of code in two or more corresponding software applications, databases, or other suitable software architectures. In one exemplary embodiment, a software system can include one or more lines of code in a general purpose software application, such as an operating system, and one or more lines of code in a specific purpose software application.

Wireless communication referred to herein may include both wireless communications and also hardwired links, and need not be exclusively wireless. Wireless communications may utilize any known and used type of communications, including for example fiber optics, cable, DSL, telephone lines, and other similar connections. Wireless communications will be understood to include where desired any number of networks capable of providing communications between the gateway 20, the smartphone 12, the Federal Reserve System 22, the consumer bank 16 and the vendor bank 18, and any vendor 20. For example, the communications network may be one or more, or any combination of, wireless networks, data or packet networks, publicly switched telephone networks (PSTN), etc.

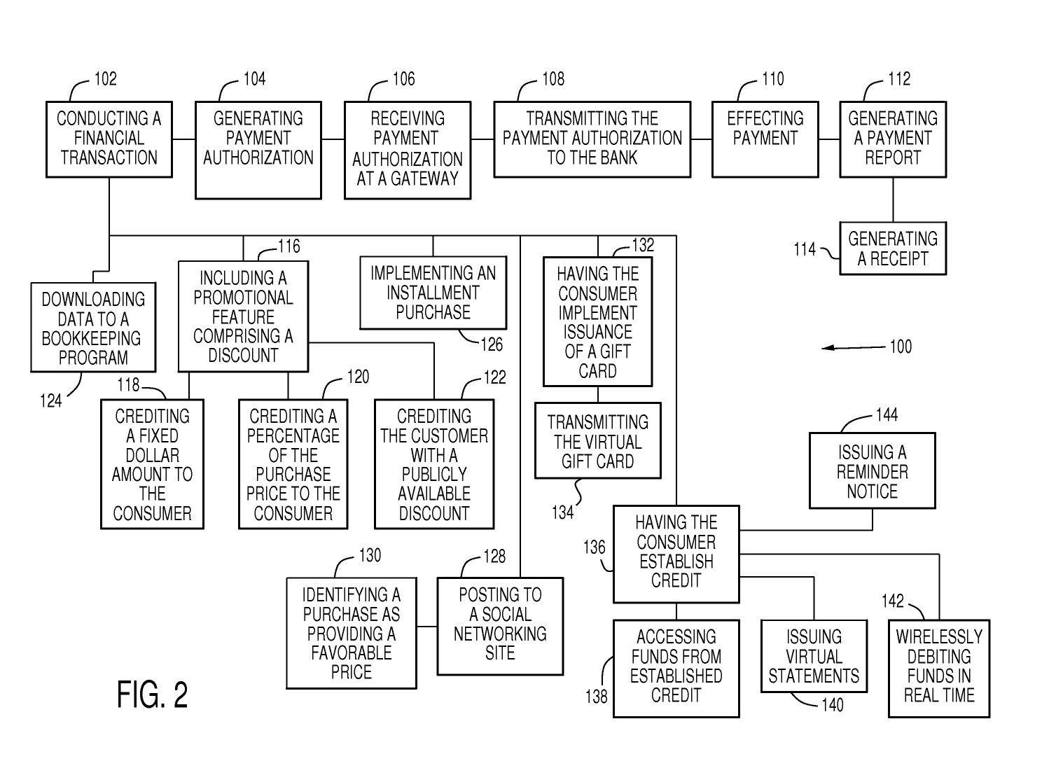

With the apparatus which may be utilized by the novel system having mostly been described, and with reference to FIG. 2, the invention may be thought of as a method 100 of conducting commercial financial transactions among consumers such as the consumer 10, vendors such as the vendor 14, and the national banking system, which may comprise the consumer bank 16, the vendor bank 18, and the Federal Reserve System 22 at a minimum, utilizing a gateway such as the gateway 20. The method 100 may comprise:

a step 102 of conducting a commercial financial transaction by the consumer such as the consumer 10, wherein a purchase is made by the consumer 10 for a commercial product of the vendor, such as the vendor 14;

a step 104 of generating a payment authorization in payment of the purchase by the consumer 10 on the portable, internet enabled telecommunications device such as the smartphone 12 and transmitting the payment authorization to the gateway 20;

a step 106 of receiving the payment authorization by the gateway 20;

a step 108 of transmitting the payment authorization wirelessly to the consumer bank 16 by the gateway 20 responsively to receiving the payment authorization;

a step 110 of effecting payment to the vendor 14 by the consumer bank 16;

a step 112 of generating a payment report by the gateway 20, wherein the payment report contains data identifying the purchase, the consumer 10, and the amount paid by the consumer 10, and transmitting the payment report to the vendor 10; and

a step 114 of generating a virtual receipt and transmitting the virtual receipt to the portable, internet enabled telecommunications device such as the smartphone 12 of the consumer 10.

In the above method 100, it should be noted that each step is effected automatically, predicated on performance of one or more prior steps. That is, no participant such as the consumer 10, the vendor 14, the consumer bank 16, or the vendor bank 18 must initiate a command or other input to keep the process going until the final step such as the step 114 is performed. The result of this method 100 is that the commercial transaction may be completed seamlessly, with the consumer 10 being able to initiate and complete the transaction easily using the smartphone 12. At the same time, necessary or desirable feedback to the vendor 14 is also seamlessly accomplished.

It will also be understood that all references to transmitting data to a party such as to the consumer 10 or to the vendor 14 signify that data is transmitted to the data processing apparatus operated by that party.

The method 100 may also comprise a step 116 of including a promotional feature as part of the commercial financial transaction, wherein value is credited to the consumer 10 automatically, and wherein the value comprises a discount which is not available to the general public and which is based on prior purchases by the consumer 10 from the vendor 14. Such discounts have been known as loyalty discounts or benefits in conventional commercial practice.

The method 100 may comprise a step 118 of including a promotional feature as part of the commercial financial transaction, wherein value is credited to the consumer automatically, and wherein the value comprises a predetermined, fixed dollar amount which is not available to the general public and which is based on prior purchases by the consumer 10 from the vendor 14. This credited value may be a loyalty benefit or may be generated by another criterion. In a variation on the step 118, the method 100 may comprise a step 120 of including a promotional feature as part of the commercial financial transaction, wherein value is credited to the consumer automatically, and the credited value comprises a predetermined percentage of the purchase price which is not available to the general public and which is based on prior purchases by the consumer from the vendor.

The method 100 may comprise a step 122 of including a promotional feature as part of the commercial financial transaction, wherein value is credited to the consumer automatically, and the value is also offered to the general public as a discount applicable for a predetermined amount of time. The benefit of the step 122 is assuring existing customers that they will not be denied discounts which are offered to the general public. In an example of how this could be implemented, if a hypothetical discount were advertised by the vendor 14 and predicated upon customers bringing a printed coupon to the retail store, then existing customers unaware of the condition of bringing a coupon might be denied the discount. The step 122 prevents denial of such a discount to existing customers, and overcomes potential resentment that might arise from such denial.

As presented herein, promotional features have been described as taking the form of monetary value. Promotional features could take other forms, such as conferring privileges to the recipient, such as authorizing entry to or participation in specified events that are otherwise restricted from participation, or may otherwise take the form on non-monetary value.

The method 100 may comprise a step 124 of, responsively to the purchase by the consumer 10, downloading financial data pertaining to at least one purchase by the consumer 10 from the vendor 14 to a bookkeeping program maintained on a personal computing device 36 operated by the consumer 10. It should be noted that this may be in place of or in addition to virtual receipts uploaded to the smartphone 10.

The method 100 may comprise a step 126 of having the consumer 10 enter an input to the smartphone 12 to implement an installment purchase by the consumer 10 from the vendor 14, wherein periodic payments are made to the vendor 14 until the dollar amount of the purchase price is satisfied by the sum of the periodic payments. This option may be regarded as implementing an installment purchase wherein merchandise or service is rendered to the consumer 10 immediately or rendered after payment is complete. The latter option is widely known as layaway sales.

The method 100 may comprise a step 128 of having the consumer 10 enter an input to the smartphone 12 to implement a posting to a social network site, such as Twitter®, Facebook®, and Google+1®, wherein the posting comprises data reflecting at least one detail of a purchase made by the consumer from the vendor. For example, the consumer 10 may post a particularly advantageous purchase price, which might serve as free advertising to the vendor 14. In another example, an image of an item acquired in the purchase may be posted, again affording the vendor 14 free advertising. The step 128 may comprise a further step 130 of identifying a purchase made by the consumer 10 from the vendor 14 as being regarded by the consumer 10 as providing a competitively favorable price to the consumer 10.

The method 100 may comprise a step 132 of having the consumer 10 enter an input to the smartphone 12 to implement issuance of a virtual gift card (not shown), and a further step 134 of automatically transmitting the virtual gift card to a portable, internet enabled data processing device operated by someone known to the consumer 10. The gift card could take the form of a printable file, or of an image which when displayed on the data processing device of the person known to the consumer 10, would qualify that person for a credit applicable to a purchase.

The method 100 may comprise a step 136 of having the consumer 10 enter an input to the smartphone 12 to wirelessly establish a credit account with a lender (not shown), and a step 138 of wirelessly and automatically accessing funds from the credit account established with the lender to fund the commercial financial transaction conducted by the consumer 10.

The method 100 may comprise a step 140 of automatically issuing virtual statements pertaining to the credit account established in the step 136, and transmitting the issued virtual statements wirelessly to the consumer 10.

The method 100 may comprise a step 142 of wirelessly debiting funds accessed by the consumer 10 from the account established for the consumer 10, or alternatively stated, automatically and wirelessly updating the account such that any balance owing reflects purchases in near real time. As employed herein, “near real time” signifies a time period not exceeding about three seconds.

The method 100 may comprise a step 144 of issuing a reminder notice and transmitting the reminder notice wirelessly to the consumer 10.

The system features regarding coupons, layaway accounts, rewards, loyalty, and an added feature of advertising and marketing are shown in FIG. 1 as being capable of being associated with and generated by the gateway 20, and more particularly by the transaction server 26, although these features could be implemented through other agency.

Integration of the above steps into a single, seamless process gives the consumer 10 the ability to track the status of positive asset accounts such as checking accounts, savings accounts, and debit accounts) and also of negative asset accounts, such as credit accounts in near real time. Also, the entire system of banking and payments may proceed to transfer payments responsively to payment authorization so as to complete transaction and financial transfers in near real time.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A method of conducting commercial financial transactions among consumers, vendors, and the national banking system, comprising the steps of:
providing a vendor having a payment data processor disposed to receive and transmit data wirelessly pertaining to commercial financial transactions related to commercial products sold by the vendor;
providing at least one consumer having a portable, internet enabled telecommunications device having data entry and data receiving capability;
providing a consumer bank having a financial account serving the consumer and a vendor bank having a data processor, memory, and apparatus for transmitting and receiving wireless communications, and to receive, record, process, and transmit data wirelessly;
providing a gateway comprising a data processor, memory, and apparatus for transmitting and receiving wireless communications, and to receive, record, process, and transmit data pertaining to commercial financial transactions wirelessly;
conducting a commercial financial transaction by the consumer, wherein a purchase is made by the consumer for a commercial product of the vendor;
generating a payment authorization in payment of the purchase by the consumer on the portable, internet enabled telecommunications device and transmitting the payment authorization to the gateway;
receiving the payment authorization by the gateway;
transmitting the payment authorization wirelessly to the bank of the consumer by the gateway responsively to receiving the payment authorization;
effecting payment to the vendor by the bank of the consumer;
generating a payment report by the gateway, wherein the payment report contains data identifying the purchase, the consumer, and the amount paid by the consumer, and transmitting the payment report to the payment data processor of the vendor; and
generating a virtual receipt and transmitting the virtual receipt to the portable, internet enabled telecommunications device of the consumer.

2. The method of claim 1, comprising the further step of locating an electronic terminal comprising a data processor, memory, and apparatus for transmitting and receiving wireless communications at the physical point of sale of the vendor.

3. The method of claim 1, comprising the further step of including a promotional feature as part of the commercial financial transaction, wherein
value is credited to the consumer automatically; and
the value comprises a discount which is not available to the general public and which is based on prior purchases by the consumer from the vendor.

4. The method of claim 1, comprising the further step of including a promotional feature as part of the commercial financial transaction, wherein
value is credited to the consumer automatically; and
the value comprises a predetermined, fixed dollar amount which is not available to the general public and which is based on prior purchases by the consumer from the vendor.

5. The method of claim 1, comprising the further step of including a promotional feature as part of the commercial financial transaction, wherein
value is credited to the consumer automatically; and
the value comprises a predetermined percentage of the purchase price which is not available to the general public and which is based on prior purchases by the consumer from the vendor.

6. The method of claim 1, comprising the further step of including a promotional feature as part of the commercial financial transaction, wherein
value is credited to the consumer automatically; and
the value is also offered to the general public as a discount applicable for a predetermined amount of time.

7. The method of claim 1, comprising the further step of downloading financial data pertaining to at least one purchase by the consumer from the vendor to a bookkeeping program maintained on a personal computing device operated by the consumer.

8. The method of claim 1, comprising the further step of having the consumer enter an input to the portable, internet enabled telecommunications device to implement an installment purchase by the consumer from the vendor, wherein periodic payments are made to the vendor until the dollar amount of the purchase price is satisfied by the sum of the periodic payments.

9. The system of claim 1, comprising the further step of having the consumer enter an input to the portable, internet enabled telecommunications device to implement a posting to a social network site, wherein the posting comprises data reflecting at least one detail of a purchase made by the consumer from the vendor.

10. The system of claim 9, comprising the further step of having the consumer enter an input to the portable, internet enabled telecommunications device to announce details identifying a purchase made by the consumer from the vendor as being regarded by the consumer as a competitively favorable price to the consumer.

11. The system of claim 1, comprising the further steps of:
having the consumer enter an input to the portable, internet enabled telecommunications device to implement issuance of a virtual gift card; and
automatically transmitting the virtual gift card to a portable, internet enabled data processing device operated by someone known to the consumer.

12. The system of claim 1, comprising the further steps of:
having the consumer enter an input to the portable, internet enabled telecommunications device to wirelessly establish a credit account with a lender; and
wirelessly and automatically accessing funds from the credit account established with the lender to fund the commercial financial transaction conducted by the consumer.

13. The system of claim 12, comprising the further step of automatically issuing virtual statements pertaining to the credit account established with the lender, and transmitting the issued virtual statements wirelessly to the consumer.

14. The system of claim 12, comprising the further step of wirelessly debiting funds accessed by the consumer from the account established for the consumer in near real time.

15. The system of claim 12, comprising the further step of issuing a reminder notice and transmitting the reminder notice wirelessly to the consumer.
